(19) United States
(12) Patent Application Publication
(10) Pub. No.: US 2003/0163535 A1
(43) Pub. Date: Aug. 28, 2003

(54) Bedside communication system

(75) Inventor: Chihiro Suzuki, Tokyo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/202,041

(22) Filed: Jul. 25, 2002

(30) Foreign Application Priority Data
Feb. 22, 2002 (JP) 2002-046519

(51) Int. Cl. G06F 15/16; G06F 17/60

(52) U.S. Cl. 709/206; 705/3

(57) ABSTRACT

A bedside communication system is configured by a hospital intranet, a server connected thereto, a client at the bedside of an inpatient, and a client in a hospital administration office. The server comprises a database to which patient information of an inpatient, and the like are registered. Furthermore, the server connects the inside of the hospital to its outside such as an external client, a cellular phone, etc.

This system allows an inpatient to make a communication with an external person while lying in a bed. Additionally, a person external to the hospital can obtain visitation time information of each inpatient with a method other than a telephone call. Furthermore, a hospital administration office can collectively contact a plurality of persons without taking a lot of trouble, when contacting emergency contact persons in case of an emergency of the inpatient.

### BACKGROUND OF THE INVENTION

1. Field of the Invention

The present invention relates to a technique for improving a service rendered to an inpatient in a hospital, and more particularly, to a technique for providing a method with which an inpatient makes a communication with a person external to a hospital by using a network.

2. Description of Related Art

In a conventional hospital, only a payphone installed in an inpatients' ward or a hospital visitation exist as methods with which an inpatient makes a communication with a person external to the hospital. Additionally, external contact to an inpatient can be only made via a nurse station.

When an inpatient makes a communication with an external person over a payphone, he must go to a site at which the payphone is installed. If the inpatient cannot move freely, for example, due to the use of a wheelchair or an intravenous drip, he must ask a nurse to help him move to the site at which the payphone is installed, and again ask the nurse to help him return to his bed after finishing the call. The inpatient cannot sometimes return to the bed after finishing the call if the nurse is busy.

For a hospital visitation, visitation time is fixed depending on a hospital or an inpatients' ward. Even within the visitation time, available or unavailable time exists depending on each inpatient. A person who makes a visitation cannot see an inpatient and is obliged to return in some cases, if the person does not know the unavailable time of the inpatient.

Additionally, since a method making external contact with an inpatient is implemented via a nurse station, it is available only in the case of an important matter. There are no casual contact methods that are available, by way of example, for little contact of the family of an inpatient, or the like.

As described above, a medical care is the top priority of actions taken for an inpatient in a hospital, and other supplementary patient services have not been studied. Almost only a payphone exists as an infrastructure of an external communication, and a method making a communication with an external person has not been considered.

Furthermore, in a conventional hospital, when contact is made to a family or an acquaintance in case of an emergency such as a sudden turn for the worse of an inpatient's condition, etc., a hospital administration office must search an inpatients' list for emergency contact persons, and must contact each of the persons. Since the hospital administration office, which is busy even with routine work, takes a lot of trouble with searching an inpatients' list for contact persons and calling each of the persons, some effective measure has been demanded also from the viewpoint of resolving a manpower shortage.

### SUMMARY OF THE INVENTION

An object of the present invention is to allow an inpatient to make a communication with an external person while lying in a bed, and to allow a person external to a hospital to obtain visitable time information of each inpatient with a method other than a telephone call. Another object of the present invention is to provide a method with which a hospital administration office can collectively contact a plurality of persons without taking a lot of trouble when contacting emergency contact persons in case of an emergency of an inpatient.

To achieve the above described objects, according to the present invention, a bidirectional communication is externally implemented by installing a client at an inpatient's bedside, and by causing an inpatient to transmit/receive e-mail by using the client. Additionally, the inpatient can register visitable time information by using the client, and a person external to a hospital, who is permitted by the inpatient to obtain the information, can make an inquiry about the information by using a Web browser. Furthermore, e-mail is generated in case of an emergency based on a plurality of emergency contact persons and a fixed statement for emergency contact, which are registered by the inpatient on the client when the inpatient enters the hospital, and the generated e-mail is collectively transmitted to the plurality of contact persons.

A preferred embodiment according to the present invention is a method with which an inpatient in a hospital externally makes a bidirectional communication without moving from his or her bed. This method comprises: assigning an e-mail address to each client installed at an inpatient's bedside; and causing an inpatient to register to a server an e-mail address of a person to/from whom the inpatient can transmit/receive e-mail by using the client when the inpatient enters the hospital; and causing the inpatient to generate e-mail and to transmit the e-mail to the registered person by using the client, or to receive e-mail from the registered person while the inpatient stays in the hospital.

Another preferred embodiment according to the present invention is a method with which an inquiry is made about visitable time information of an inpatient in a hospital externally to the hospital. This method comprises: causing the inpatient to register to a server a person who can make an inquiry about the visitable time information by using a client installed at a bedside when the inpatient enters the hospital; causing the inpatient to register to the server the visitable time information by using the client as occasion demands, while the inpatient stays in the hospital; and causing the person who can make an inquiry to obtain the registered information from the server by using a Web browser.

A further preferred embodiment according to the present invention is a method with which contact is made to persons external to a hospital in case of an emergency of an inpatient in a hospital. This method comprises: causing the inpatient to register to a server e-mail addresses of a plurality of persons to whom contact is made in case of an emergency, and a fixed statement for emergency contact by using a client installed at the bedside of the inpatient when the inpatient enters the hospital; causing the server to generate e-mail with the fixed statement and to collectively transmit the e-mail to the plurality of registered persons in case of an emergency; and causing the server to register a reply from the plurality of registered persons as a history.

According to the present invention, it becomes much easier than with a conventional method that an inpatient makes a communication with an external person, whereby the inpatient is relieved of a feeling of alienation, and mental strain can be reduced. Furthermore, a manpower shortage in hospital operations can be also resolved.

### BRIEF DESCRIPTION OF THE DRAWINGS

FIG. 1 shows the whole of a system according to the present invention;

FIG. 2 shows the outline of a process performed when a patient enters a hospital;

Externally to exemplify a client screen, which is displayed at the time of patient information registration, when the patient enters a hospital;

FIG. 4 shows the data structure of the patient information that is registered when the patient enters the hospital;

FIG. 5 shows the outline of a process for transmitting e-mail;

FIG. 6 shows the outline of a process for receiving e-mail;

FIG. 7 exemplifies a screen of a client;

FIG. 8 exemplifies a screen of an external client;

FIG. 9 shows the outline of a process performed when visitation time information is registered;

FIG. 10 exemplifies a screen of a client, which is displayed when visitation time information is registered;

FIG. 11 shows the data structure of the visitation time information;

FIG. 12 shows the outline of a process performed when visitation time information is referenced;

FIG. 13 exemplifies a screen of a client when visitation time information is displayed;

FIG. 14 shows the outline of a process performed in case of an emergency;

FIG. 15 exemplifies a screen of a client when e-mail is transmitted in case of emergency;

FIG. 16 exemplifies a screen when an external client receives e-mail in case of an emergency;

FIG. 17 shows the outline of a process performed when a patient leaves a hospital;

FIG. 18 shows the configuration of a server according to the present invention;

FIG. 19 shows the configuration of an information processing device; and

FIG. 20 shows a method providing a program, etc.

### DESCRIPTION OF THE PREFERRED EMBODIMENTS

Hereinafter, a preferred embodiment according to the present invention is described in detail with reference to the drawings.

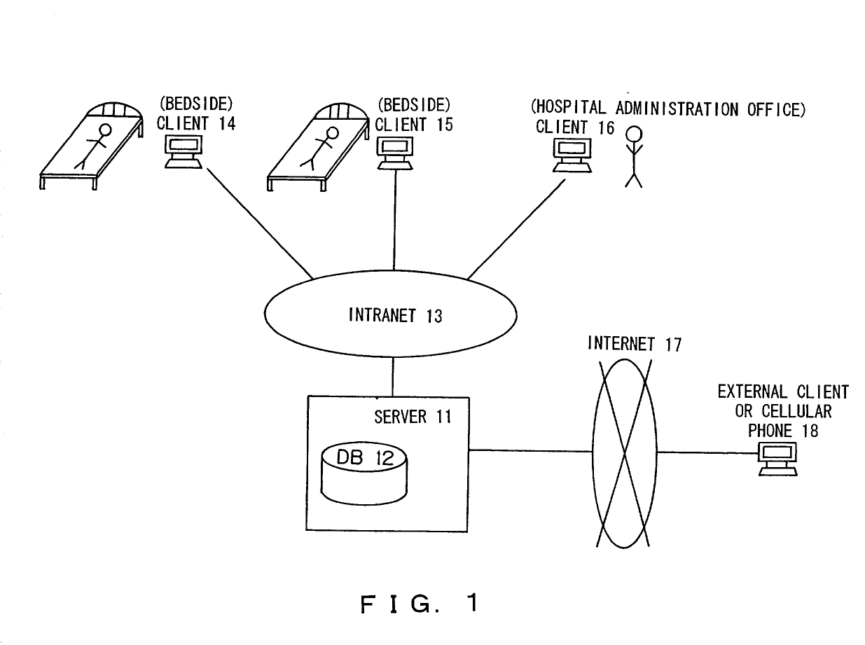

FIG. 1 shows the whole of a system according to the present invention. A bedside communication system according to the present invention is mainly configured by a hospital intranet 13, a server 11 connected thereto, clients 14 and 15 at the bedside of inpatients, and a client 16 in a hospital administration office. The server 11 comprises a database 12 (hereinafter abbreviated to DB) to which patient information, etc. of an inpatient, etc. is registered. Furthermore, the server 11 plays a role of connecting the outside of the hospital, such as an external client, a cellular phone 18, etc. and the inside of the hospital via the Internet 17.

To the clients connected to the hospital intranet 13, unique e-mail addresses are respectively assigned. As a result, the inpatients can make a bidirectional communication with a person external to the hospital without moving from their beds by exchanging e-mail by using the clients 14, 15, and the like.

Additionally, an inpatient registers, for example, visitation time information of the inpatient, etc. to the DB 12 of the server 11 from the client 14, 15, or the like, so that a person external to the hospital can make an inquiry about the registered information by using a Web browser, etc.

Furthermore, if e-mail addresses of emergency contact persons to whom emergency contact is made, an emergency message, etc. are preregistered as patient information within the DB 12, e-mail can be collectively transmitted from the server 11 to the plurality of persons in case of an emergency.

The configuration shown in FIG. 1 is adopted as described above, so that the above described objects are proved to be achieved. Outlines of the processes performed by the system according to the present invention are respectively described in further detail by using the reference numerals of the constituent elements of the system shown in FIG. 1 for cases such as (1) a case where a patient enters a hospital, (2) a case where a bidirectional communication is made with e-mail, (3) a case where an inquiry is made about visitation time information externally to a hospital, (4) a case where contact is made to emergency contact persons in case of an emergency of the patient, and (5) a case where the patient leaves the hospital. The following explanation is provided by taking as an example a process started by an operation of a single client. However, a similar operation can be performed from a plurality of bedside clients.

(1) The Case Where a Patient Enters a Hospital

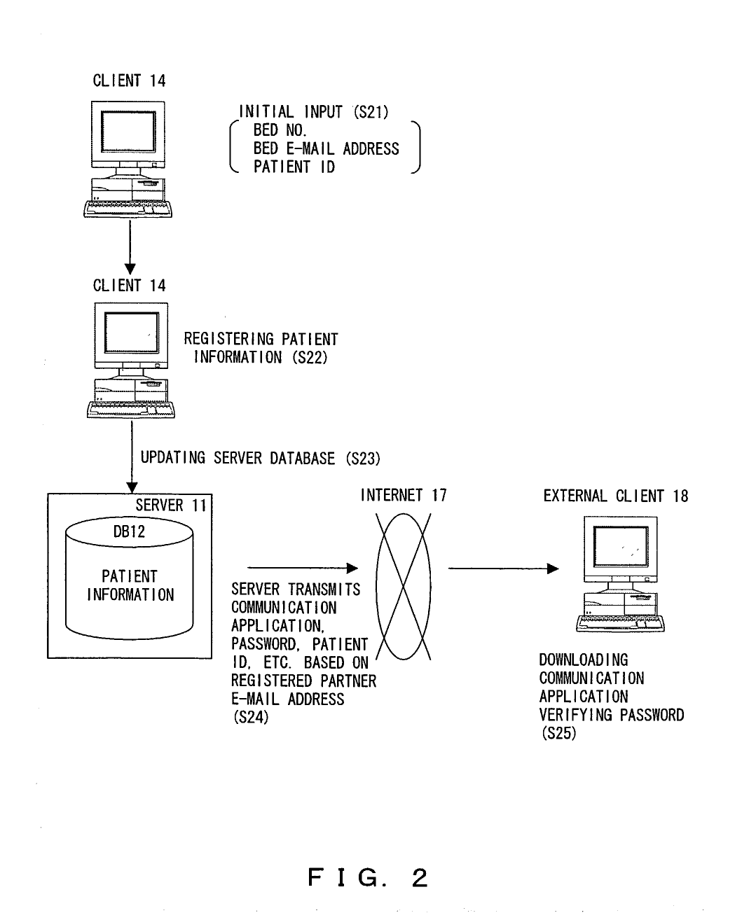

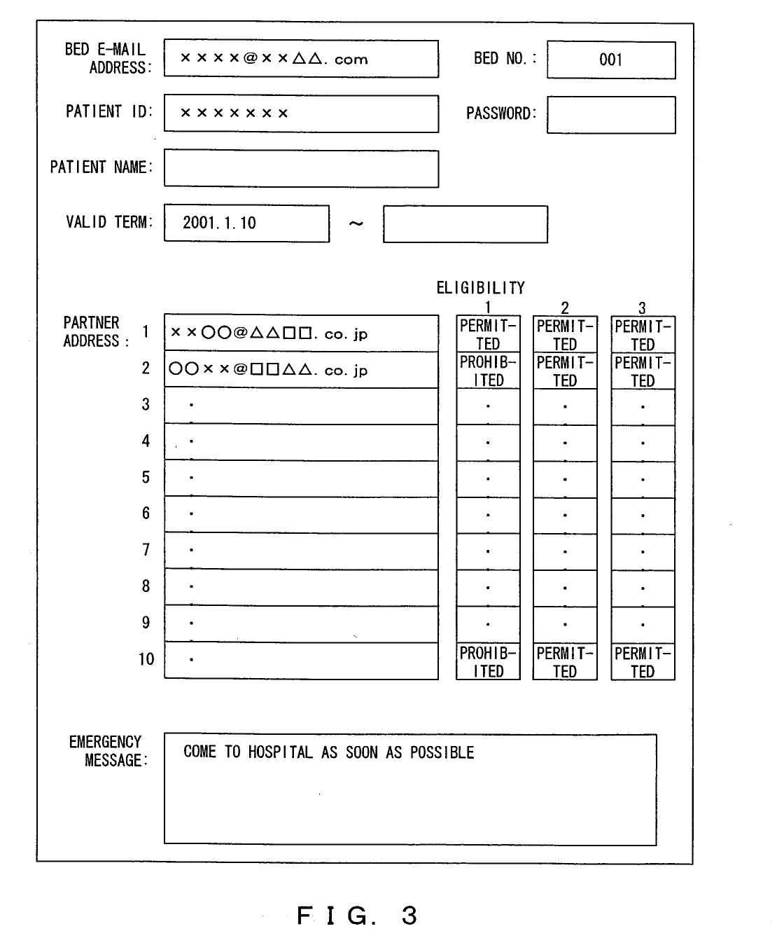

The case where a patient enters a hospital is explained with reference to FIGS. 2 to 4. Firstly, the outline of a process performed by the system according to the present invention is shown in FIG. 2.

On the client 14, a patient inputs a bed number, a bed e-mail address, and a patient ID, which are notified from a hospital side (S21). The bed number and the bed e-mail address are a number and an e-mail address, which are assigned to a bedside client and unique to the system. The bed number and the bed e-mail address are fixed even if an inpatient changes.

As a result of the input made in S21, a plurality of input fields for registering patient information is displayed on the client 14. The patient registers patient information by inputting corresponding information to the input fields (S22). The patient information is composed of a bed number, a subnumber, a bed e-mail address, a patient ID, a patient name, a password, a valid term of the patient information, an e-mail address of a partner with whom e-mail is exchanged, information indicating a partner to whom an emergency message is transmitted, information indicating a person who can reference visitation time information, an emergency message reception state, a fixed statement of an emergency message, etc.

Then, the server 11 updates the patient information within the DB 12 (S23), and transmits a communication application, a password, the patient ID, etc. based on the e-mail address of the registered partner (S24). The communication application, the password, the patient ID, etc. are received by the external client 18 via the Internet 17 (S25).

A screen of the client 14, which is displayed when patient information is registered (S22 of FIG. 2), is exemplified in FIG. 3. The above described plurality of input fields for registering patient information are displayed on this screen.

A bed e-mail address, a patient ID, and a bed number are notified from a hospital side, and input by a patient in S21 of FIG. 2. Therefore, these are fields in which an input by a patient is not accepted at this time point (S22 of FIG. 2).

For the password, its initial value is set on the hospital side. However, it is necessary for a patient to arbitrarily change when patient information is registered. This password is used to authenticate an external person by checking whether or not an external person who attempts to reference visitation time information is permitted when the external person references the visitation time information, and transmitted from the server 11 to the external client 18 in S24 of FIG. 2.

For the patient name, the patient inputs his or her name.

The valid term indicates a time period from a date on which patient information is registered to a date on which the patient leaves the hospital. For this input field, a patient inputs the date on which the patient information is registered as the start date of the valid term (the date is registered on the left side of “˜”). However, the end date of the valid term may be empty when a patient enters a hospital, because a hospital administration office inputs this date when the patient leaves the hospital.

To the partner addresses, a plurality of e-mail addresses of partners with whom a patient desires to exchange e-mail. For each of the partners, 1) whether an emergency message transmission is either permitted or prohibited, 2) whether e-mail transmission/reception is either permitted or prohibited, and 3) whether a reference of visitation time information is either permitted or prohibited are determined, and determination results are set as “permitted” or “prohibited” respectively in eligibility fields 1, 2, and 3. Note that all of the initial values of the eligibility fields are “prohibited”. Additionally, value 1 and value 2 are respectively assigned in case of “permitted” and “prohibited”.

To the emergency message field, a message that is desired to be transmitted to persons to whom emergency contact is desired to be made is input in case of an emergency of a patient.

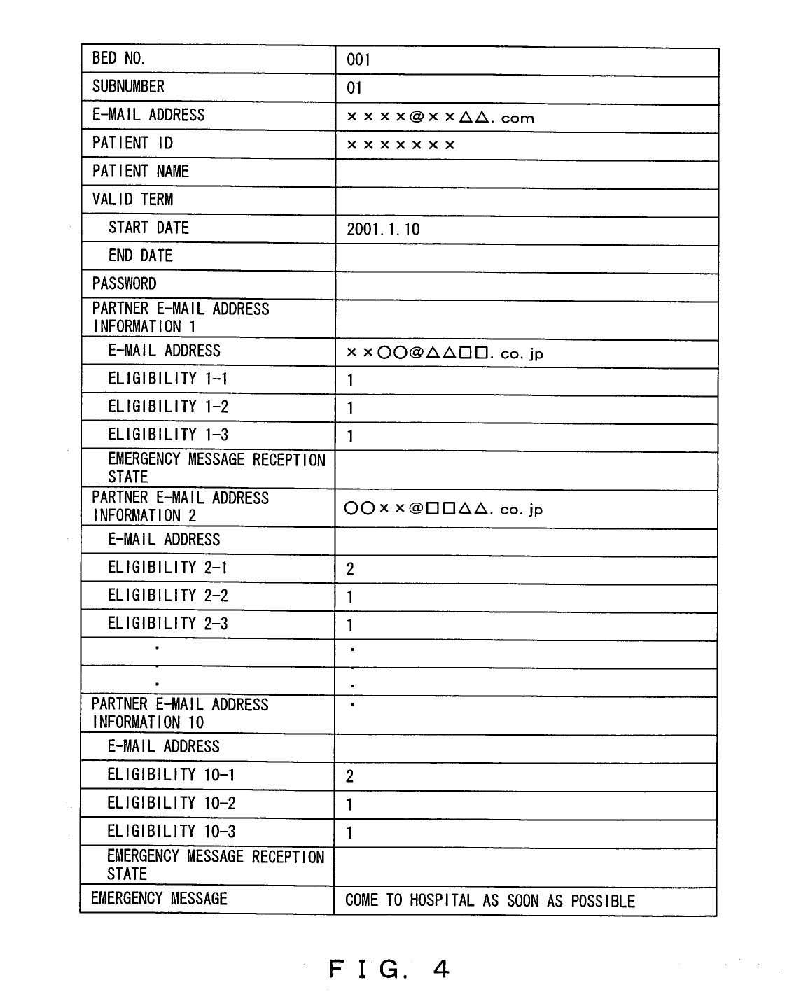

FIG. 4 shows the data structure of the patient information registered when a patient enters a hospital. FIG. 4 takes the patient information shown in FIG. 3 as an example. In this example, the structure where the information in the input fields shown in FIG. 3 is sequentially arranged from the top is adopted. However, data such as a “subnumber” and an “emergency message reception state”, which are not shown in FIG. 3, are added.

The subnumber is used to manage the record of each valid term for the same bad. By way of example, if the patient information of a previous patient has a subnumber 01, and a valid term from the start date “2001.1.10” to the end date “2001.11.30” for a bed number 001, the subnumber of the next patient at the time of patient information registration becomes 02, and the valid term ranges from the start date “2001.12.1” to the end date “yet to be input”. By using such a subnumber, the valid term of each changing patient can be easily managed.

The emergency message reception state is appended to the end of e-mail address information of each partner, and indicates whether or not a partner has received the emergency message, and whether or not the partner has viewed the message.

Up to this point, the process performed when a patient enters a hospital is explained.

(2) The Case Where a Bidirectional Communication is Made with E-Mail

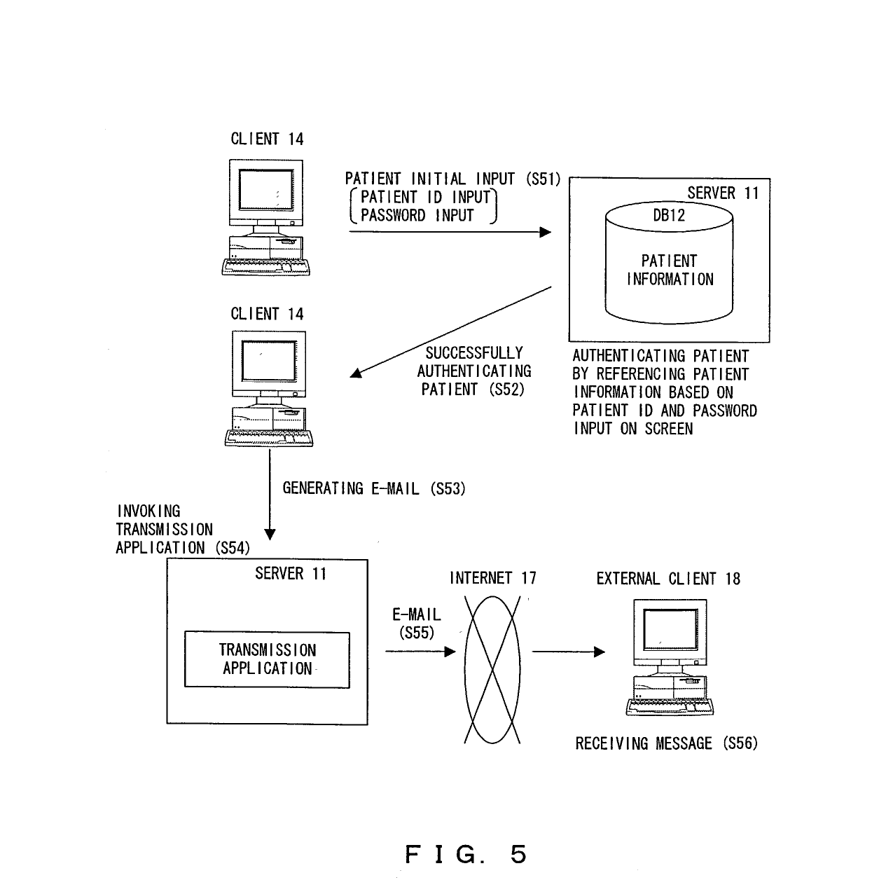

The case where a bidirectional communication is externally made with e-mail is explained with reference to FIGS. 5 to 8. Firstly, the outline of a process in which a patient externally transmits e-mail is shown in FIG. 5.

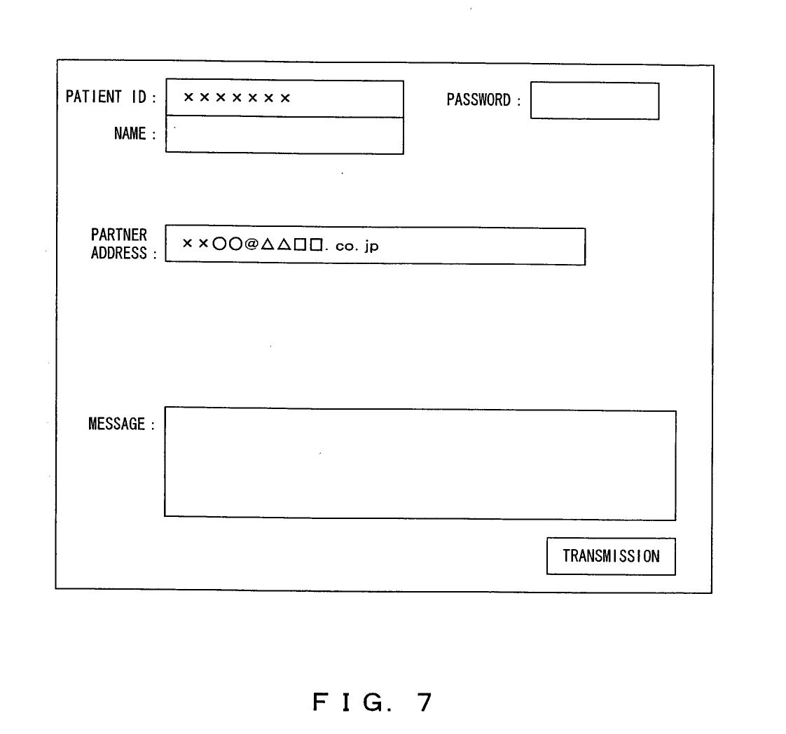

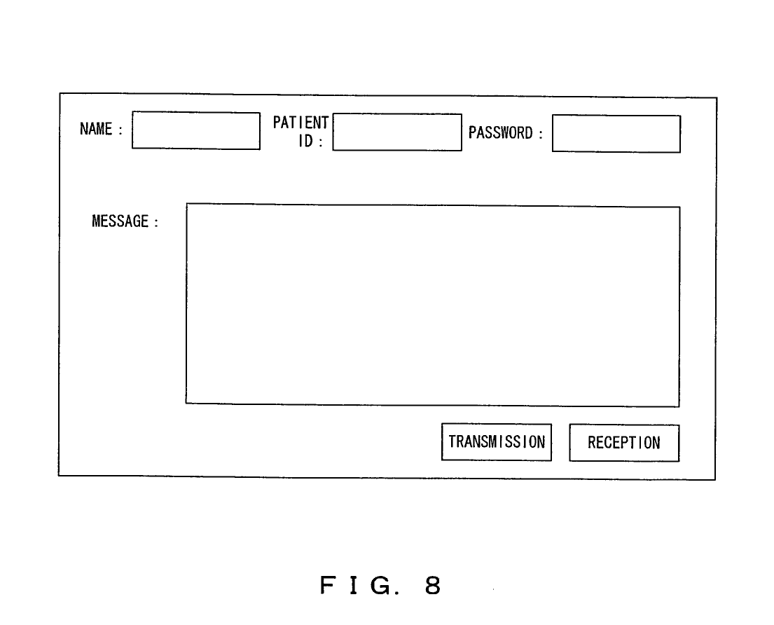

On the client 14, a patient inputs a patient ID and a password (S51). The server 11 authenticates the patient by referencing the patient information within the DB 12 based on the input patient ID and password. If the server 11 successfully authenticates the patient (S52), the client 14 displays a window for generating e-mail, etc. (the screen of the client 14 is exemplified in FIG. 7), and the patient generates e-mail (S53). When the patient has generated the e-mail, and issues a transmission instruction, for example, by pressing a transmission button, etc., the server 11 invokes a transmission application (S54). Then, the e-mail is transmitted from the transmission application (S55), and received by the external client 18 via the Internet 17 (S56). The screen of the external client 18 in S56 is exemplified in FIG. 8.

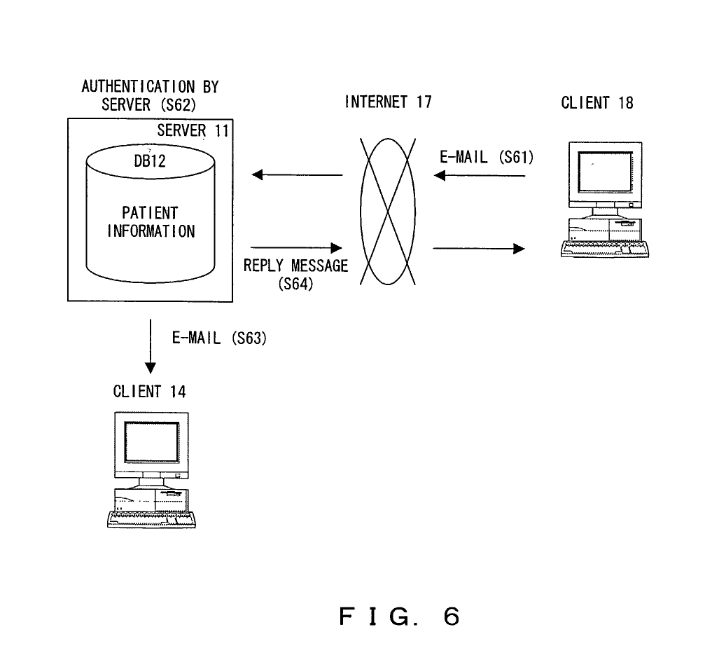

The outline of a process in which a patient externally receives e-mail is shown in FIG. 6.

On the external client 18, e-mail including a patient ID and a password is generated (the screen of the external client 18 is exemplified in FIG. 8), and transmitted (S61). Then, the e-mail is received by the server 11 via the Internet 17. The server 11 references the patient information within the DB 12 based on the patient ID and the password, which are included in the transmitted e-mail, and checks whether or not the e-mail address of the transmitter of the transmitted e-mail corresponds to the partner address that the patient registers when entering the hospital (S62).

If the e-mail address of the transmitter of the transmitted e-mail corresponds to the registered partner address, the patient can read the e-mail on the client 14 (S63).

If the e-mail address of the transmitter of the transmitted e-mail does not correspond to the registered partner address, it is further checked whether or not the e-mail address corresponds to a partner address that a previous patient registered. If the e-mail address corresponds to the partner address that the previous patient registered, e-mail notifying that the patient has left the hospital is returned to the transmitter of the e-mail (S64) . If the e-mail address does not correspond also to the partner address that the previous patient registered, e-mail notifying that the e-mail cannot be received is transmitted to the transmitter of the e-mail (S64).

By performing the transmission process (FIG. 5) and the reception process (FIG. 6) as described above, an inpatient can make a bidirectional communication with a partner external to a hospital, whom the inpatient registers when entering the hospital, with e-mail.

Here, FIGS. 7 and 8 are explained. FIG. 7 exemplifies a window that is displayed when e-mail is generated on the client 14. In this window, a patient generates e-mail by inputting a partner address to which the patient transmits e-mail, and by also inputting a message to a message field. After generating the e-mail, the patient issues a transmission instruction by pressing a transmission button represented at the bottom of the window. In the meantime, FIG. 8 exemplifies a window that is displayed when e-mail is generated or read on the external client 18. When e-mail is generated, a patient name, a patient ID, and a password, which are registered and transmitted to the external client 18 when the patient enters a hospital, are input, and a message desired to be notified to the patient is input to a message field. Then, a transmission button at the bottom of the window is pressed, so that the e-mail is transmitted. Or, when e-mail is read, the message from the patient is displayed in the message field.

Up to this point, the bidirectional communications using e-mail are explained.

(3) The Case Where an Inquiry is Made about Visitation Time Information Externally to a Hospital

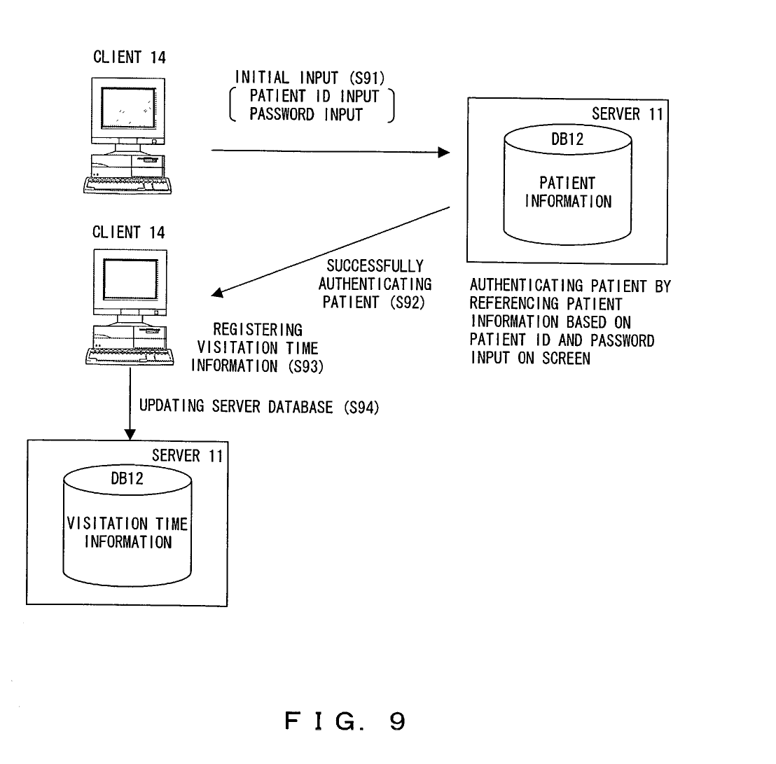

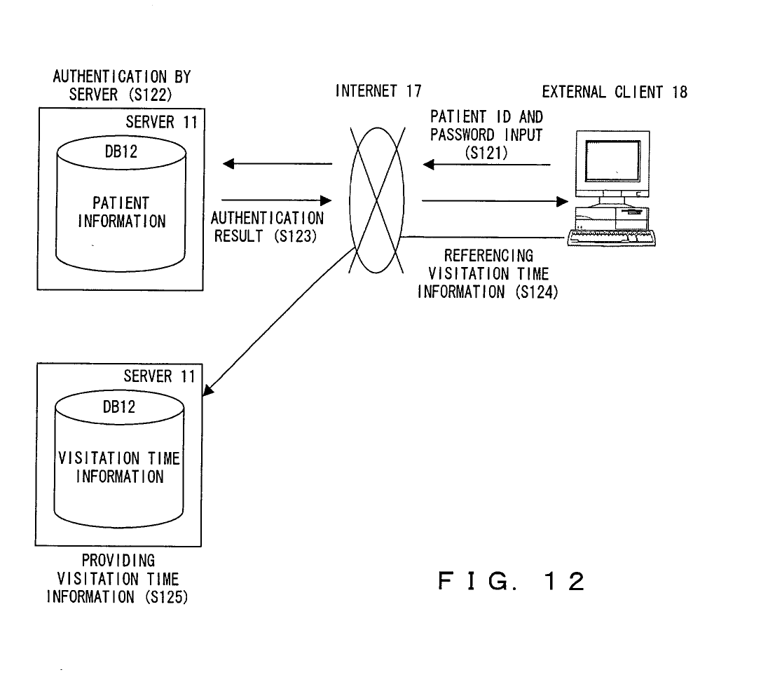

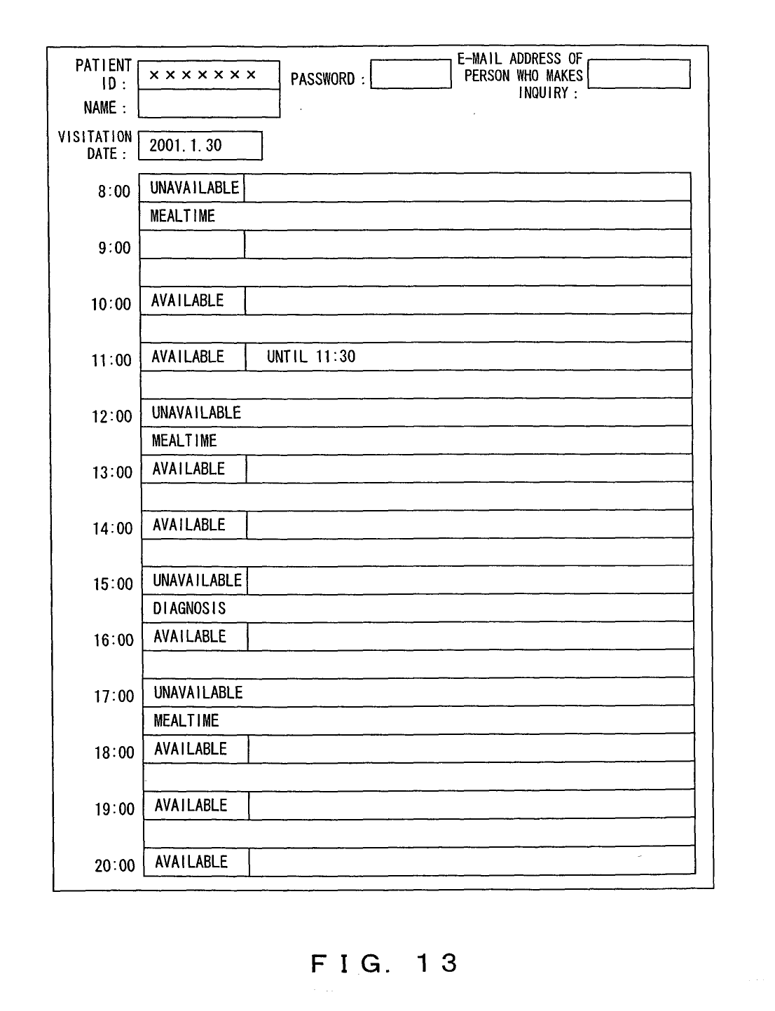

The case where an inquiry is made about visitation time information externally to a hospital is explained with reference to FIGS. 9 to 13. Registration of visitation time information is firstly explained with reference to FIGS. 9 to 11, and an inquiry that is made externally to a hospital is next explained with reference to FIGS. 12 and 13.

FIG. 9 shows the outline of a process for registering visitation time information.

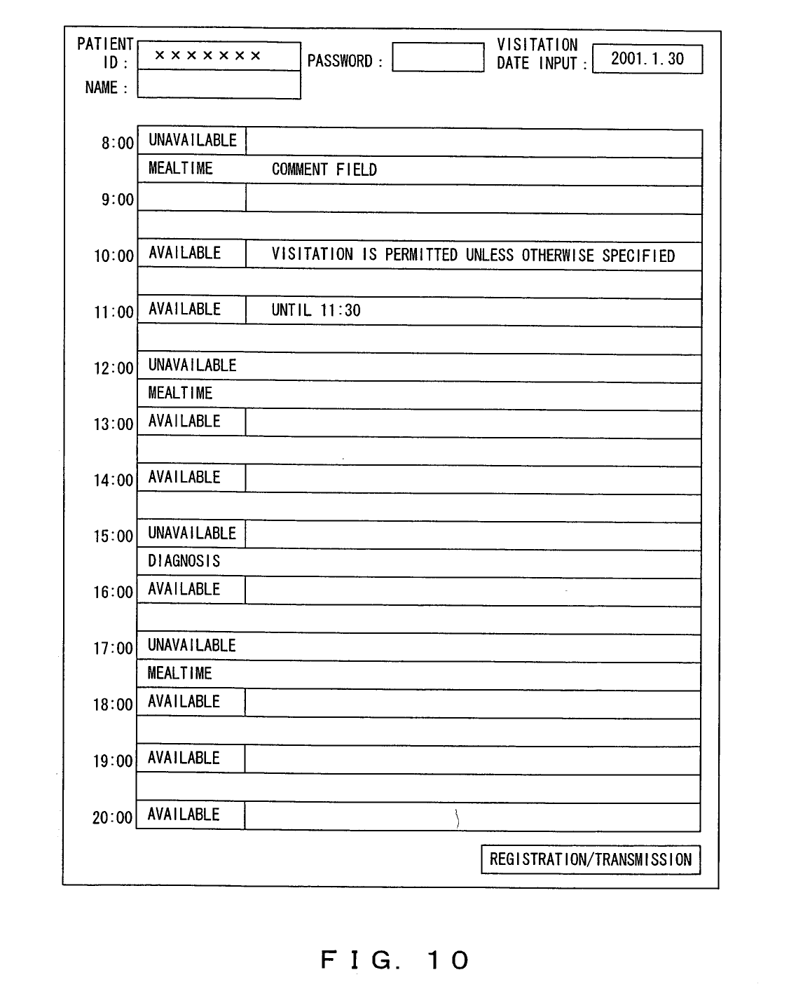

On the client 14, a patient inputs a patient ID and a password (S91). The server 11 authenticates the patient by referencing the patient information within the DB 12 based on the input patient ID and password. If the server 11 successfully authenticates the patient (S92), the client 14 displays a window for inputting visitation time information (the screen of the client 14 is exemplified in FIG. 10), etc., and the patient inputs information (S93). When the patient has input the information, and issues a registration instruction, for example, by pressing a registration button, the server 11 updates the visitation time information within the DB 12 (S94).

The screen of the client 14 when a patient registers visitation time information is exemplified in FIG. 10. On this screen, visitable times that are preset by a hospital are displayed, and a patient inputs whether he or she is either available or unavailable (“available” or “unavailable” is input in FIG. 10), and also inputs a comment, a note, etc. to a comment field. By pressing a registration/transmission button at the bottom of the window, the DB 12 of the server 11 is updated with the input information.

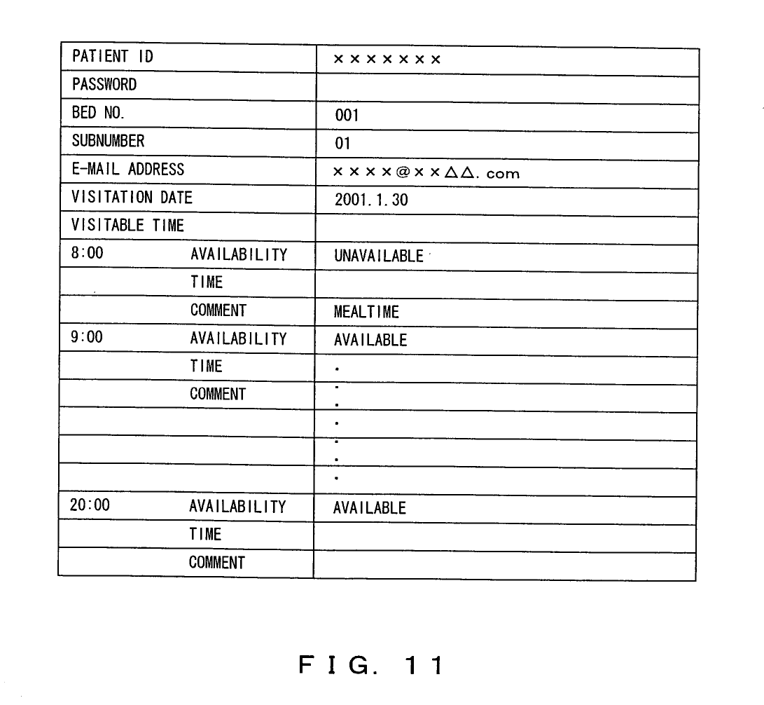

The data structure of the visitation time information is shown in FIG. 11. This figure takes the visitation time information shown in FIG. 10 as an example. The visitation time information is composed of a patient ID, a password, a bed number, a subnumber, an e-mail address of a patient, a visitation date, a visitable time (for each time), etc.

Next, the outline of the process performed when the visitation time information is referenced externally to a hospital is shown in FIG. 12.

On the external client 18, a patient ID desired to be inquired, a password, and an e-mail address of a person who makes an inquiry are input by using a Web browser, etc. (S121). The input patient ID, password, and e-mail address are received by the server 11 via the Internet 17. The server 11 checks whether or not a match is found with the input patient ID and password by referencing the patient information within the DB 12 based on the patient ID and the password. If a match is found, the server 11 then authenticates (the person by checking?) whether or not the input e-mail address matches the e-mail address of a person who can reference the visitation time information, who is registered when the patient enters the hospital (S122) . Then, the result of the authentication is notified to the external client 18 (S123). If the visitation time information can be referenced (S124), it is displayed on a Web browser, etc. (S125).

A screen of the external client 18, which is displayed when the visitation time information is inquired, is shown in FIG. 13. A patient ID field, a password field, and a filed of an e-mail address of a person who makes an inquiry are those input in S121 of FIG. 12. After it is notified that the visitation time information can be referenced in S123 of FIG. 12, a visitation date can be input. Upon input of the visitation date, the schedule of the patient on the corresponding day is displayed. This schedule is the visitation time information registered by the patient.

Up to this point, the process performed when visitation time information is inquired externally to a hospital is explained.

(4) The Case Where Contact is Made to an Emergency Contact Person in Case of an Emergency of a Patient

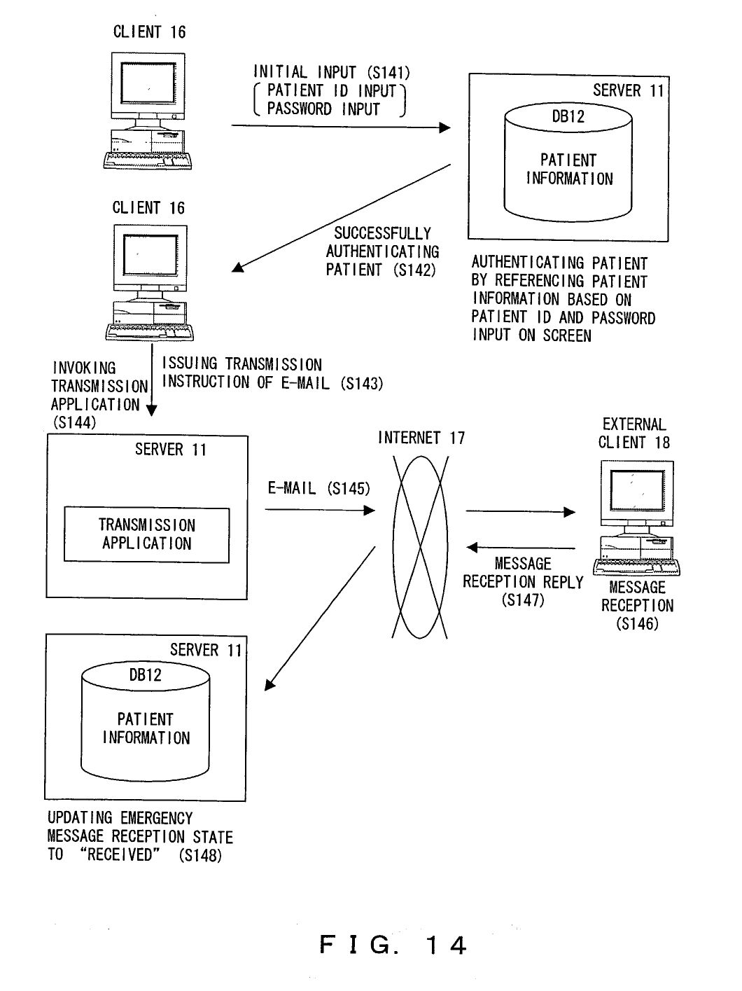

The case where contact is made to an emergency contact person in case of an emergency is explained with reference to FIGS. 14 to 16. The outline of the process performed by the system according to the present invention is firstly shown in FIG. 14.

On the client 16 on a hospital administration office side, a patient ID and a password are input (S141) This password is managed by the hospital administration office side, and used only when an emergency message is transmitted. The server 11 authenticates the patient by referencing the patient information within the DB 12 based on the input patient ID and password. When the server 11 successfully authenticates the patient (S142) and the client 16 issues a transmission instruction of e-mail (S143), the server 11 invokes a transmission application (S144). Then, the e-mail is transmitted (S145), and received by the external client 18 (S146). When the e-mail is read and a reception button (to be described later) is pressed on the external client 18, a message reception reply notifying that the e-mail has been read is transmitted to the server 11 (S147). Upon receipt of the message reception reply by the server 11, it updates an emergency message reception state to “received” (S148).

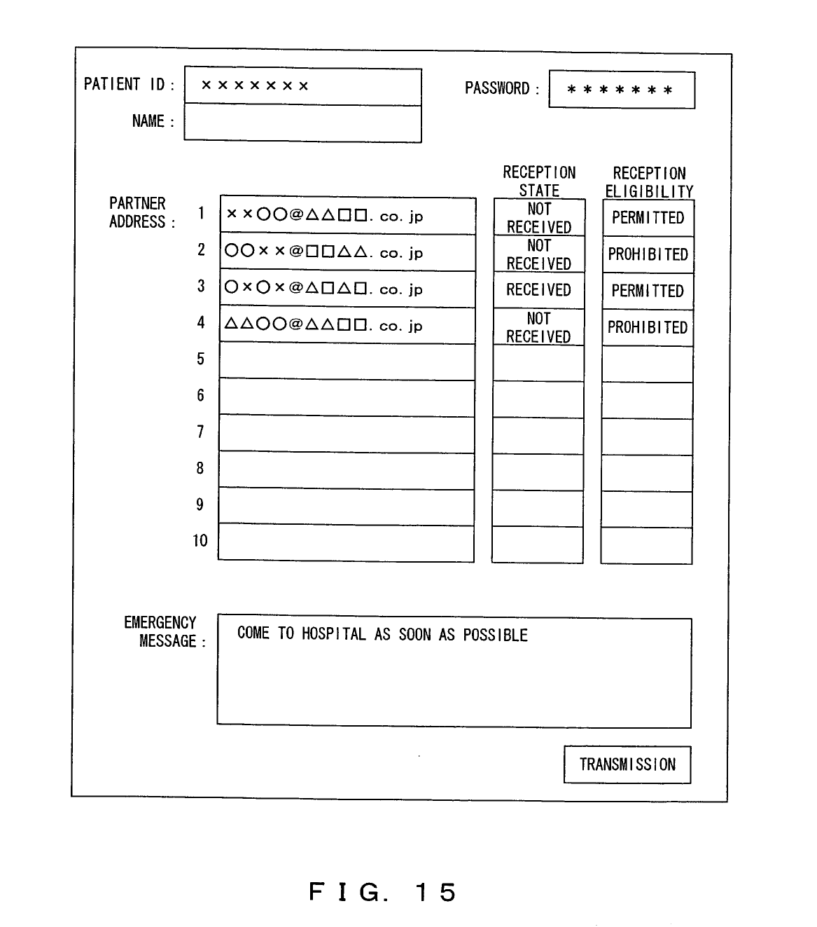

FIG. 15 exemplifies the screen of the client on the hospital administration office side, which is displayed when e-mail is transmitted in an emergency. When inputs are made to patient ID and password fields, a patient name, a partner address, a reception state, reception eligibility, and an emergency message, which are registered when the patient enters the hospital, are displayed. Then, a transmission button at the bottom of the window is pressed, so that a transmission instruction of e-mail is issued to the server 11. Although all of reception states are “not received” when e-mail is transmitted, they are updated to “received” when external persons read the e-mail after the emergency e-mail is transmitted.

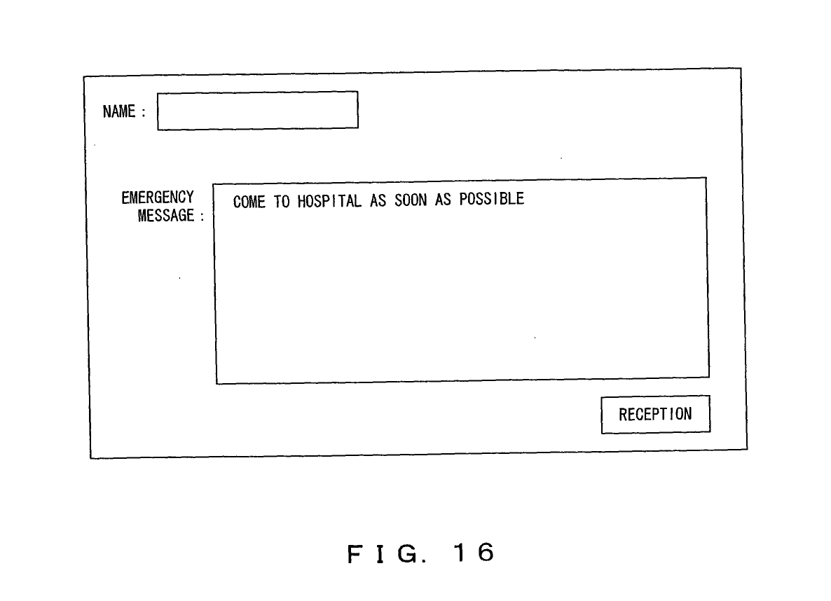

FIG. 16 exemplifies a screen that is displayed when the external client 18 receives e-mail in case of an emergency. An emergency message is displayed in an emergency message field. The above described reception button at the bottom of the window is pressed, so that message reception e-mail is automatically transmitted to the server 11, and the emergency message reception state of the server 11 is updated to “received”. In this way, the reception states shown in FIG. 15 are updated to “received”.

Up to this point, the process performed in the case where contact is made to an emergency contact person in case of an emergency of a patient is explained.

(5) The Case Where a Patient Leaves a Hospital

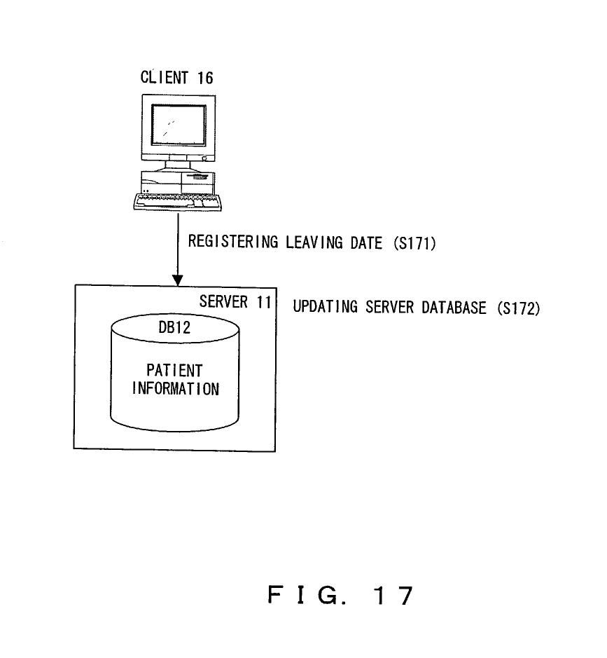

The outline of the process performed by the system according to the present invention when a patient leaves a hospital is shown in FIG. 17.

On the client 16 on a hospital administration office side, an administration staff, etc. registers a leaving date of a patient (S171). Then, the server 11 updates the DB 12 (S172) . As a result of this update, the entire patient information registered by the patient is erased, and an e-mail address that the patient registers as a partner address is reregistered as “previously registered e-mail address information”. The “previously registered e-mail address information” is used to notify a transmitter of e-mail that a corresponding patient has already left the hospital, when the e-mail is transmitted to the patient after the patient has left the hospital (see S64 of FIG. 6).

Up to this point, the process performed when a patient leaves a hospital is explained.

The outlines of the processes performed by the system are described above. Next, the server 11 implementing the system according to the present invention is explained in detail.

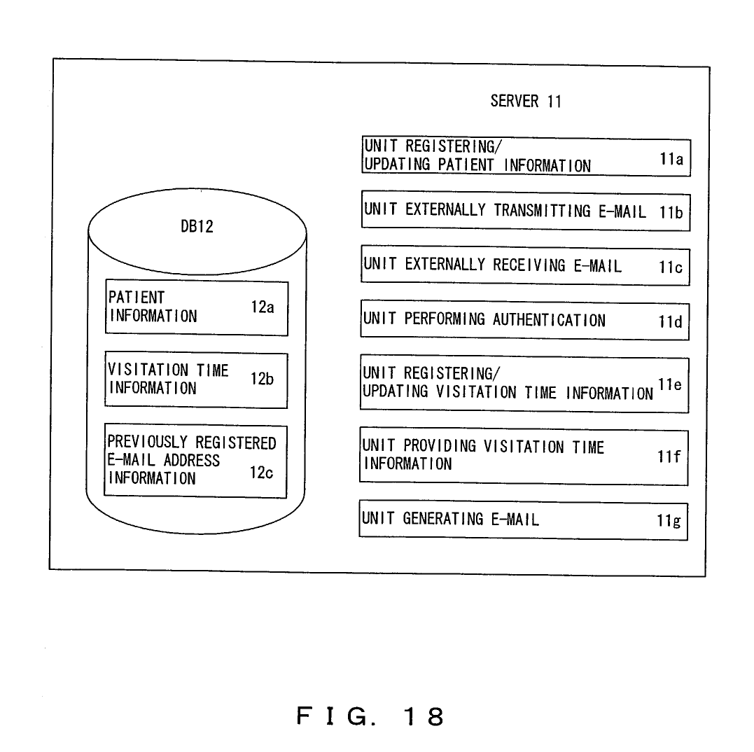

Configuration of the server 11 is shown in FIG. 18.

The server 11 comprises a unit 11a registering/updating patient information, a unit 11b externally transmitting e-mail, a unit 11c externally receiving e-mail, a unit 11d performing authentication, a unit 11e registering/updating visitation time information, a unit 11f providing visitation time information, a unit 11g generating e-mail, and the like. The server 11 further comprises a database 12 which includes patient information 12a, visitation time information 12b, previously registered e-mail address information 12c, and the like. The units are implemented by a program.

The unit 11a registering/updating patient information is a unit that functions when patient information is registered when a patient enters a hospital. This unit registers the patient information input on the client 14, etc. to the patient information 12a within the DB 12, or updates the patient information 12a with the input patient information. Or, this unit updates a partner address, which is registered to the patient information 12a, as the previously registered e-mail address information 12c when the patient leaves the hospital.

The unit 11b externally transmitting e-mail, and the unit 11c externally receiving e-mail are units that function when e-mail is transmitted and received.

The unit 11d performing authentication is a unit performs authentication by checking whether or not a match is found with a patient ID and a password, whether or not the destination address of e-mail to be transmitted is permitted, whether or not the source address of received e-mail is permitted, and the like.

The unit 11e registering/updating visitation time information is a unit that functions when visitation time information is registered. This unit registers the visitation time information input on the client 14, etc. to the visitation time information 12b within the DB 12, or updates the visitation time information 12b with the input visitation time information.

The unit 11f providing visitation time information is a unit that provides visitation time information 12b of a corresponding patient, when an inquiry is externally made about a visitation time.

The unit 11g generating e-mail is a unit that generates a message notifying that externally received e-mail cannot be received, or generates e-mail from emergency contact persons and an emergency contact message, which are registered to the patient information 12a, in case of an emergency.

These units operate respectively in cases such as (1) the case where a patient enters a hospital, (2) the case where a bidirectional communication is made with e-mail, (3) the case where an inquiry is made about visitation time information externally to a hospital, (4) the case where contact is made to an emergency contact person in case of an emergency of a patient, and (5) the case where a patient leaves a hospital, whereby the above described service can be rendered to a patient and persons external to a hospital.

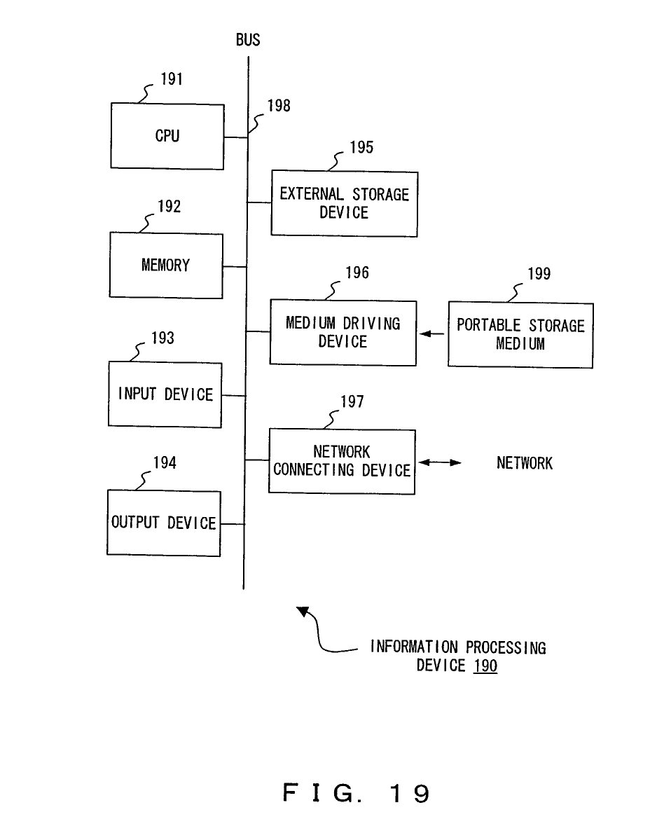

The server 11 and the clients, which are referred to in the system according to the present invention, can be configured by using an information processing device (computer) shown in FIG. 19. The information processing device 190 shown in FIG. 19 comprises a CPU 91, a memory 192, an input device 193, an output device 194, an external storage device 195, a medium driving device 196, and a network connecting device 197, which are interconnected by a bus 198.

The memory 192 includes, for example, a ROM (Read-Only Memory), a RAM (Random Access Memory), etc., and stores a program and data, which are used for processes. The CPU 191 performs necessary processes by executing the program with the memory 192.

The respective units configuring the server 11 of the system according to the present invention are stored as a program in a particular program code segment in the memory 192.

The input device 193 is, for example, a keyboard, a pointing device, etc., whereas the output device 194 is, for example, a display, etc.

The external storage device 195 is, for example, a magnetic disk device, an optical disk device, a magneto-optical disk device, etc. The above described program and data may be stored in the external storage device 195, and used by being loaded into the memory 192 depending on need. The memory 192 and/or the external storage device 195 configure the DB 12 of the server 11.

The medium driving device 196 drives a portable storage medium 199, and accesses its stored contents. As the portable storage medium 199, an arbitrary computer-readable storage medium such as a memory card, a memory stick, a flexible disk, a CD-ROM (Compact Disk-Read-Only Memory), an optical disk, a magneto-optical disk, a DVD (Digital Versatile Disk), etc. is used. The above described program and data may be stored onto the portable storage medium 199, and used by being loaded into the memory 192 depending on need.

The network connecting device 197 connects the clients, etc. and the server 11 via an arbitrary network. The above described program and data may be received from an external device, and used by being loaded into the memory 192 depending on need.

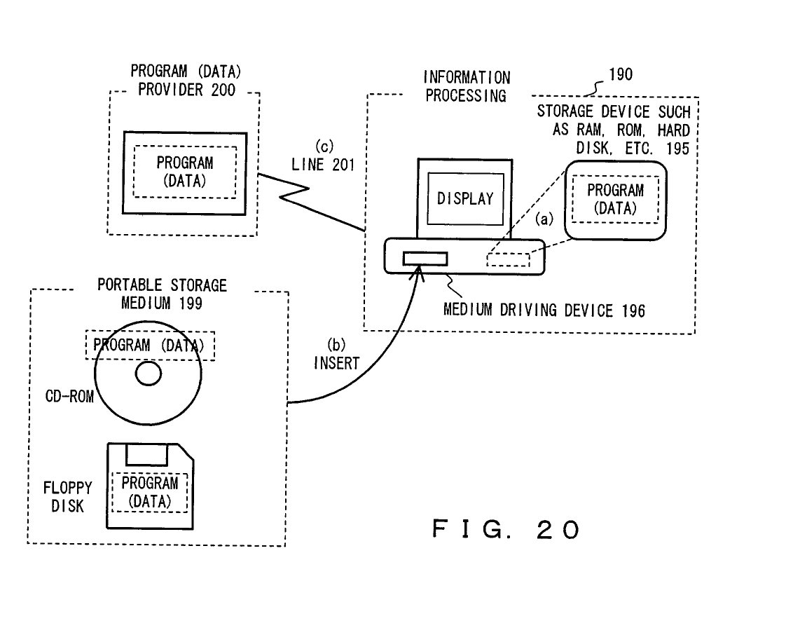

FIG. 20 explains a method providing the program, the data, and the like, which are used by the server 11 according to the present invention. The program, etc. are provided, for example, with an arbitrary one of the following 3 methods (a) to (c).

(a) Stored in the external storage device 195 such as a RAM, a ROM, a hard disk, etc. of the information processing device 190 being a computer, etc. In this case, the program, etc are prestored, for example, prior to shipment.

(b) Provided by being stored onto the portable storage medium 199 such as a CD-ROM, a flexible disk, etc. In this case, the program, etc. are stored in the external storage device 195 or the memory 192 of the information processing device 190 being a computer, etc.

(c) Provided from a provider 200 that is connected by a network (line) 201. In this case, fundamentally, the program, etc. stored by the provider 200 are downloaded by the information processing device 190 being a computer, etc., so that they are obtained.

As described above in detail, according to the present invention, it becomes much easier than with a conventional method that an inpatient makes a communication with an external person, whereby the inpatient is relieved of a feeling of alienation, and mental strain is reduced. Furthermore, a manpower shortage in hospital operations can be also resolved.

What is claimed is:

1. A method with which an inpatient in a hospital externally makes a bidirectional communication by using a client installed at a bedside of the inpatient without moving from a bed, comprising:
causing a server to obtain an e-mail address of a person who can transmit/receive e-mail to/from the inpatient, and to register the e-mail address to a database, when the inpatient enters the hospital; and
causing the server to determine whether or not a destination address of e-mail generated by using the client is the registered e-mail address, and to externally transmit the generated e-mail, or to determine whether or not a source address of e-mail transmitted to an e-mail address of the client is the registered e-mail address, and to receive the transmitted e-mail while the inpatient stays in the hospital.

2. The method according to claim 1, wherein
if the source address of the received e-mail is not the registered e-mail address, the server notifies the source that the e-mail cannot be received at present.

3. A method with which an inquiry is made about visitation time information of an inpatient in a hospital externally to the hospital, comprising:
causing a server to obtain information of a person who can make an inquiry about the visitation time information of the inpatient, and to register the information to a database, when the inpatient enters the hospital; and
causing the server to obtain the visitation time information of the inpatient, to register the visitation time information to the database, and to provide the registered visitation time information on request from the person who can make an inquiry about the visitation time information as occasion demands, while the inpatient stays in the hospital.

4. A method with which contact is made to a person external to a hospital in case of an emergency of an inpatient in a hospital, comprising:
causing a server to obtain e-mail addresses of a plurality of persons to whom contact is made in case of an emergency, and a fixed statement for emergency contact, and to register the e-mail addresses and the fixed statement to a database, when the inpatient enters the hospital; and
causing the server to generate e-mail with the fixed statement, to collectively transmit the e-mail to the plurality of registered persons in case of an emergency, and to register a reply from the plurality of registered persons to the database as a history.

5. The method according to claim 1, 3 or 4, further comprising
erasing entire registered information from the database, when the inpatient leaves the hospital.

6. A program for causing a computer to execute a process, with which an inpatient in a hospital externally makes a bidirectional communication without moving from a bed, the process comprising:
registering a person who can transmit/receive e-mail to/from the inpatient;
transmitting e-mail generated by the inpatient;
receiving e-mail addressed to the inpatient; and
determining whether or not received e-mail is e-mail from the person who is registered by the inpatient and can transmit/receive e-mail, transmitting the e-mail to the inpatient if the received e-mail is from the registered person, or notifying a transmitter of the e-mail that the e-mail cannot be received if the received e-mail is not from the registered person.

7. A program for causing a computer to execute a process, with which an inquiry can be made about visitation time information of an inpatient in a hospital externally to the hospital, the process comprising:
registering a person who can make an inquiry about the visitation time information of the inpatient;
registering the visitation time information;
authenticating a person external to the hospital by checking whether or not a person external to the hospital is the person who can make an inquiry about the visitation time information, when the person external to the hospital attempts to make an inquiry about the visitation time information; and
providing the registered visitation time information.

8. A program for causing a computer to execute a process, with which contact is made to a person external to a hospital in case of an emergency of an inpatient in the hospital, the process comprising:
registering e-mail addresses of a plurality of persons to whom contact is made in case of an emergency;
registering a fixed statement for emergency contact;
generating e-mail with the e-mail addresses and the fixed statement in case of the emergency;
collectively transmitting the e-mail to the plurality of persons; and
registering a reply to the transmitted e-mail as a history.

9. The program according to claim 6, 7, or 8, the process further comprising
erasing entire information registered by the inpatient, when the inpatient leaves the hospital.

10. A computer-readable storage medium on which is recorded a program for causing a computer to execute a process, with which an inpatient in a hospital externally makes a bidirectional communication without moving from a bed, the process comprising:
registering a person who can transmit/receive e-mail to/from the inpatient;
transmitting e-mail generated by the inpatient;
receiving e-mail addressed to the inpatient; and
determining whether or not received e-mail is e-mail from the person who is registered by the inpatient and can transmit/receive e-mail, transmitting the e-mail to the inpatient if the received e-mail is from the registered person, or notifying a transmitter of the e-mail that the e-mail cannot be received if the received e-mail is not from the registered person.

11. A computer-readable storage medium on which is recorded a program for causing a computer to execute a process, with which an inquiry can be made about visitation time information of an inpatient in a hospital externally to the hospital, the process comprising:
registering a person who can make an inquiry about the visitation time information of the inpatient;
registering the visitation time information;
authenticating a person external to a hospital by checking whether or not a person external to the hospital is the person who can make an inquiry about the visitation time information, when the person external to the hospital attempts to make an inquiry about the visitation time information; and
providing the registered visitation time information.

12. A computer-readable storage medium on which is recorded a program for causing a computer to execute a process, with which contact is made to a person external to a hospital in case of an emergency of an inpatient in the hospital, the process comprising:
registering e-mail addresses of a plurality of persons to whom contact is made in case of an emergency;
registering a fixed statement for emergency contact;
generating e-mail with the e-mail addresses and the fixed statement in case of the emergency;
collectively transmitting the e-mail to the plurality of persons; and
registering a reply to the transmitted e-mail as a history.

13. The computer-readable storage medium according to claim 10, 11, or 12, the process further comprising
erasing entire information registered by the inpatient, when the inpatient leaves the hospital.

14. An information processing device with which an inpatient in a hospital externally makes a bidirectional communication without moving from a bed, comprising:
a unit registering a person who can transmit/receive e-mail to/from the inpatient;
a unit transmitting e-mail generated by the inpatient;
a unit receiving e-mail addressed to the inpatient; and
a unit determining whether or not received e-mail is e-mail from the person who is registered by the inpatient, transmitting the e-mail to the inpatient if the received e-mail is from the registered person, or notifying a transmitter of the e-mail that the e-mail cannot be received if the received e-mail is not from the registered person.

15. An information processing device with which an inquiry can be made about visitation time information of an inpatient in a hospital externally to the hospital, comprising:
a unit registering a person who can make an inquiry about the visitation time information of the inpatient;
a unit registering the visitation time information;
a unit authenticating a person external to the hospital by checking whether or not a person external to the hospital is the person who can make an inquiry about the visitation time information, when the person external to the hospital attempts to make an inquiry about the visitation time information; and
a unit providing the registered visitation time information.

16. An information processing device with which contact is made to a person external to a hospital in case of an emergency of an inpatient in a hospital, comprising:
a unit registering e-mail addresses of a plurality of persons to whom contact is made in case of an emergency;
a unit registering a fixed statement for emergency contact;
a unit generating e-mail with the e-mail addresses and the fixed statement in case of the emergency;
a unit collectively transmitting the e-mail to the plurality of persons; and
a unit registering a reply to the transmitted e-mail as a history.

17. The information processing device according to claim 14, 15, or 16, further comprising
a unit erasing entire information registered by the inpatient, when the inpatient leaves the hospital.

18. A method with which an inpatient in a hospital makes a bidirectional communication with an external person without moving from a bed, while the inpatient stays in the hospital, comprising:
causing the inpatient to transmit e-mail to an external person by using an information processing device installed at a bedside of the inpatient; and
causing the inpatient to receive e-mail from an external person by using the information processing device.

19. A method with which an inquiry is made about visitation time information of an inpatient in a hospital externally to the hospital, comprising:
registering visitation time information of each inpatient; and
causing only a person who is permitted by the inpatient to make an inquiry about the visitation time information by using a Web browser externally to the hospital.

20. A method with which contact is made to a person external to a hospital in case of an emergency of an inpatient in the hospital, comprising:
notifying preregistered emergency contact persons with e-mail; and
registering a reply from the emergency contact persons as a history.
